(19) United States
(12) Patent Application Publication
(10) Pub. No.: US 2026/0106508 A1
(43) Pub. Date: Apr. 16, 2026

(54) MOTOR

(71) Applicant: TOYOTA JIDOSHA KABUSHIKI KAISHA, Toyota-shi (JP)

(72) Inventor: Kengo OHIRA, Toyota-shi (JP)

(73) Assignee: TOYOTA JIDOSHA KABUSHIKI KAISHA, Toyota-shi (JP)

(21) Appl. No.: 19/219,025

(22) Filed: May 27, 2025

(30) Foreign Application Priority Data
Oct. 16, 2024 (JP) 2024-180926

(51) Int. Cl. H02K 3/34; H02K 3/28; H02K 15/104; H02K 15/35

(52) U.S. Cl. CPC H02K 3/34; H02K 3/28; H02K 15/104; H02K 15/35

(57) ABSTRACT

The motor includes a stator core having a plurality of slots, a stator coil disposed in the slots and configured by connecting a plurality of segment coils, and an insulating material configured by a foaming material having insulation property and covering each connection portion of the segment coils. Each connection portion of the segment coils has a structure in which each end portion in which the conductor portions of two segment coils are exposed is inserted from both ends into a fitting member having a cylindrical shape, at least one through-hole is formed in a side wall of the fitting member having a cylindrical shape, and the insulating material extends from the inside of the fitting member to the outside through at least one through-hole.

### CROSS-REFERENCE TO RELATED APPLICATION

This application claims priority to Japanese Patent Application No. 2024-180926 filed on Oct. 16, 2024. The disclosure of the above-identified application, including the specification, drawings, and claims, is incorporated by reference herein in its entirety.

### BACKGROUND

### 1. Technical Field

The technique disclosed in the present specification relates to a motor.

### 2. Description of Related Art

Japanese Unexamined Patent Application Publication No. 2019-126153 (JP 2019-126153 A) discloses a motor. The motor includes a stator core including a plurality of slots, and a stator coil disposed in the slots and configured by connecting a plurality of segment coils. The connection portion of the segment coils has a structure in which each end portion of two segment coils where a conductor portion is exposed is fitted into both ends of a fitting member from each end of the fitting member having a cylindrical shape.

### SUMMARY

In each slot, several of the segment coils are arranged side-by-side, and two or more of the connection portions are positioned adjacent to each other. In each connection portion, the conductor portion of the segment coil is exposed, such that insulation property between adjacent connection portions needs to be secured.

The present disclosure provides a technique for improving the insulation property at a connection portion of segment coils.

A motor according to a first aspect of the present disclosure includes
a stator core including a plurality of slots,
a stator coil disposed in the slots and configured by connecting a plurality of segment coils, and
an insulating material made of a foaming material having insulation property, the insulating material covering each connection portion of the segment coils.

Each connection portion of the segment coils has a structure in which each end portion of two segment coils where a conductor portion is exposed is fitted into both ends of a fitting member from each end of the fitting member having a cylindrical shape.

At least one through-hole is provided in a side wall of the fitting member having a cylindrical shape.

The insulating material extends from an inside of the fitting member to an outside of the fitting member through the at least one through-hole.

In the above configuration, each connection portion of the segment coils is covered with the insulating material, and thus insulation property is secured between adjacent connection portions. In addition, with the above configuration, after the end portions of the two segment coils are connected to each other via the fitting member, the raw material of the foaming material that is disposed inside the fitting member is heated (that is, foamed), such that the insulation property can be easily realized.

In an embodiment of the present technique, at least one through-hole may include a pair of through-holes that open in opposite directions to each other. With the above configuration, it is possible to extend the insulating material symmetrically with respect to the fitting member at the connection portion of the segment coils.

In the above-described embodiment, through-holes that open in opposite directions may face each other in a direction orthogonal to an axial direction of the fitting member having the cylindrical shape. With this configuration, the insulating material can be extended more symmetrically with respect to the fitting member at the connection portion of the segment coils.

In an embodiment of the present technique, the insulating material may be made of a thermosetting resin.

With the above configuration, even in a case where the insulating material is reheated, the shape of the insulating material is maintained. That is, the insulation property of the insulating material is maintained.

A method of manufacturing a motor according to a second aspect of the present disclosure, the method includes
disposing a raw material of a foaming material having insulation property in an inside of a fitting member having a cylindrical shape,
connecting, after the disposing, end portions of two segment coils, where conductor portion is exposed, via the fitting member in slots of a stator core, and
foaming, after the connecting, the raw material of the foaming material positioned in the inside of the fitting member by heating the raw material.

At least one through-hole is provided in a side wall of the fitting member having the cylindrical shape.

In the foaming step, the foaming material is expanded from the inside of the fitting member to an outside of the fitting member through the at least one through-hole to form an insulating material that covers a connection portion of the two segment coils.

With the manufacturing method, the motor according to the present technique can be easily manufactured.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a cross-sectional view schematically showing a configuration of a motor 2 in the present example;

FIG. 2 is an enlarged view of a II part in FIG. 1;

FIG. 3 is a diagram showing a step of disposing a raw material of a foaming material in the inside of a fitting member, which is one step of the manufacturing method of the motor 2;

FIG. 4 is a diagram showing a step of connecting end portions of two segment coils through a fitting member in one step of the manufacturing method of the motor 2; and

FIG. 5 is a diagram showing a step of heating and foaming a raw material of a foaming material located inside a fitting member, which is a step in a manufacturing method of the motor 2.

### DETAILED DESCRIPTION OF EMBODIMENTS

The motor 2 of the embodiment will be described with reference to the drawings. The motor 2 of the present example can be employed, for example, as a drive source that drives wheels of a battery electric vehicle (BEV). In addition, the configuration of the motor 2 described in the present embodiment is not limited to the three-phase alternating current motor, and can be similarly adopted in other types of electric motors.

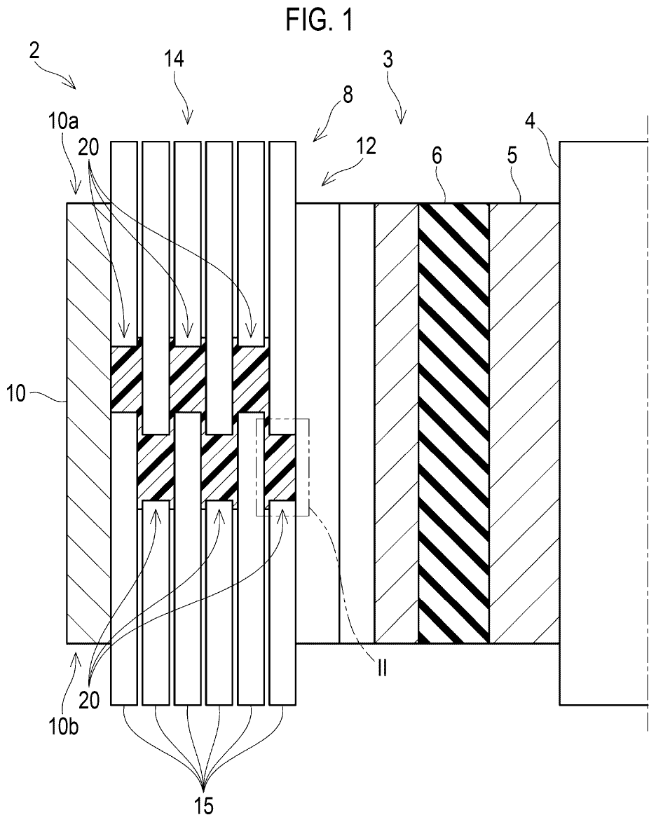

As shown in FIG. 1, the motor 2 of the present example includes a rotor 3 and a stator 8. The rotor 3 is constituted of a shaft 4 extending along the axial direction, a rotor core 5 provided on an outer peripheral surface of the shaft 4, and a magnet 6 installed in the rotor core 5. The rotor core 5 is made of a soft magnetic material, such as electromagnetic steel.

The stator 8 includes a stator core 10, a plurality of slots 12 provided in the stator core 10, and stator coils 14. The stator core 10 is made of a soft magnetic material, such as an electromagnetic steel. The stator core 10 has a cylindrical shape and extends between a first end surface 10a and a second end surface 10b along an axial direction. A plurality of slots 12 are formed on an inner peripheral surface of the stator core 10. The slots 12 are arranged along the circumferential direction. Each of the slots 12 extends along the axial direction.

The stator coil 14 is configured by connecting a plurality of segment coils 15. Each of the segment coils 15 is inserted from the first end surface 10a or the second end surface 10b of the stator core 10 to the inside of the slot 12. Then, each of the segment coils 15 is connected to the other segment coils 15 in the slot 12. That is, a plurality of connection portions 20 is formed in each of the slots 12 of the stator core 10, and the pair of segment coils 15 is connected to each other at each of the connection portions 20.

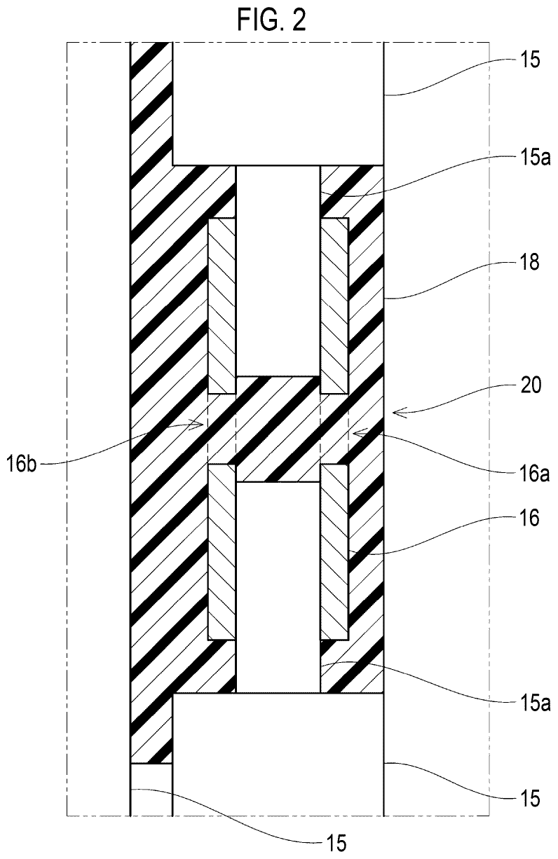

As shown in FIG. 2, a fitting member 16 is provided at a connection portion 20 of a pair of segment coils 15. The fitting member 16 has a cylindrical shape and is made of a metal such as copper. Each of the end portions 15a of the pair of segment coils 15 is press-fitted into the fitting member 16 from both sides. At each of the end portions 15a of the segment coil 15, the conductor portion of the segment coil 15 is exposed. As a result, the pair of segment coils 15 are connected to each other mechanically and electrically through the fitting member 16.

Two through-holes 16a, 16b are formed in the side wall of the fitting member 16 having a cylindrical shape. The two through-holes 16a, 16b are open in opposite directions to each other. Although not particularly limited, the two through-holes 16a, 16b are provided at the same position with respect to the axial direction (the vertical direction in FIG. 2) of the fitting member 16. That is, the two through-holes 16a, 16b face each other in a direction orthogonal to the axial direction of the fitting member 16. As another embodiment, the two through-holes 16a, 16b may be offset from each other in the axial direction (the vertical direction in FIG. 2) of the fitting member 16.

In the motor 2 of the present example, the insulating material 18 is provided in the slot 12 of the stator core 10. The insulating material 18 is provided to cover the connection portions 20 of the segment coils 15. That is, each of the end portions 15a of the segment coil 15 in which the conductor portion is exposed and the fitting member 16 connecting the end portions 15a are covered with the insulating material 18. The insulating material 18 extends from the inside to the outside of the fitting member 16 through the two through-holes 16a, 16b. The insulating material 18 not only covers the fitting member 16, but also covers the conductor portion of the segment coil 15, so that sufficient insulation property can be secured between the two adjacent connection portions 20.

The insulating material 18 of the present example is made of a foaming material having insulation property. The foaming material as used herein broadly means a material having a porous structure, and is not particularly limited to a manufacturing method thereof. The material that constitutes the insulating material 18 may be a polymer material, such as a thermosetting resin. Note that the insulating material 18 may be made of a material other than the thermosetting resin.

The stator coil 14 of the present example includes a U-phase coil, a V-phase coil, and a W-phase coil. The U-phase coil, the V-phase coil, and the W-phase coil have different positions in the circumferential direction in the stator core 10, but have the same other configurations. The specific configuration of the rotor 3 and the stator 8 is not particularly limited.

### Manufacturing Method

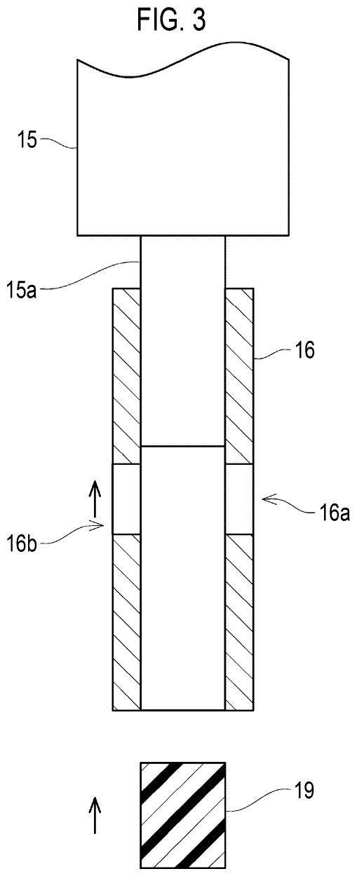

A method of manufacturing the motor 2 of the present embodiment will be described with reference to FIGS. 3, 4, and 5. The method of manufacturing the motor 2 includes a step of connecting a plurality of segment coils 15 to configure the stator coil 14. First, as shown in FIG. 3, the fitting member 16 is press-fitted into the end portion 15a of one of the pair of segment coils 15 to be connected. Then, the raw material 19 of the foaming material is disposed in the fitting member 16 from the opposite side to the direction in which the end portion 15a of the segment coil 15 is press-fitted. Although not particularly limited, the raw material 19 of the foaming material may be a thermoplastic resin containing a foaming agent. The foaming agent generates gas by being heated, and changes the raw material 19 into a foaming material. Thereafter, the segment coil 15 to which the fitting member 16 is attached is inserted into the slot 12 from the first end surface 10a side of the stator core 10.

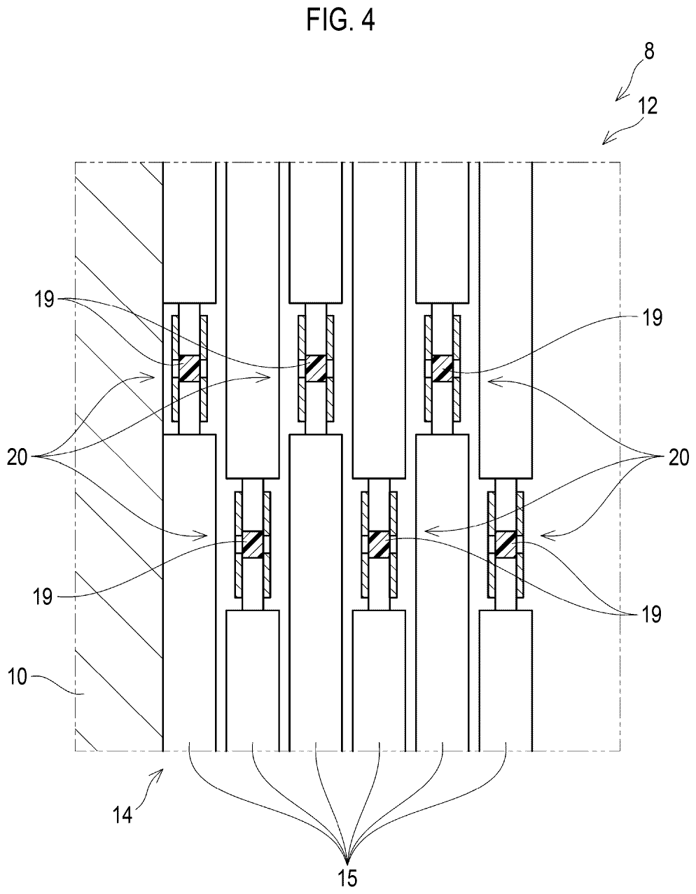

Thereafter, the other segment coil 15 of the pair of segment coils 15 is inserted into the slot 12 from the second end surface 10b side. As shown in FIG. 4, the end portion 15a of the segment coil 15 is press-fitted into the fitting member 16 inside the slot 12. With the above step, the connection portion 20 of the pair of segment coils 15 is formed. At the connection portion 20, the raw material 19 of the foaming material is positioned between the end portions 15a of the pair of segment coils 15 inside the fitting member 16.

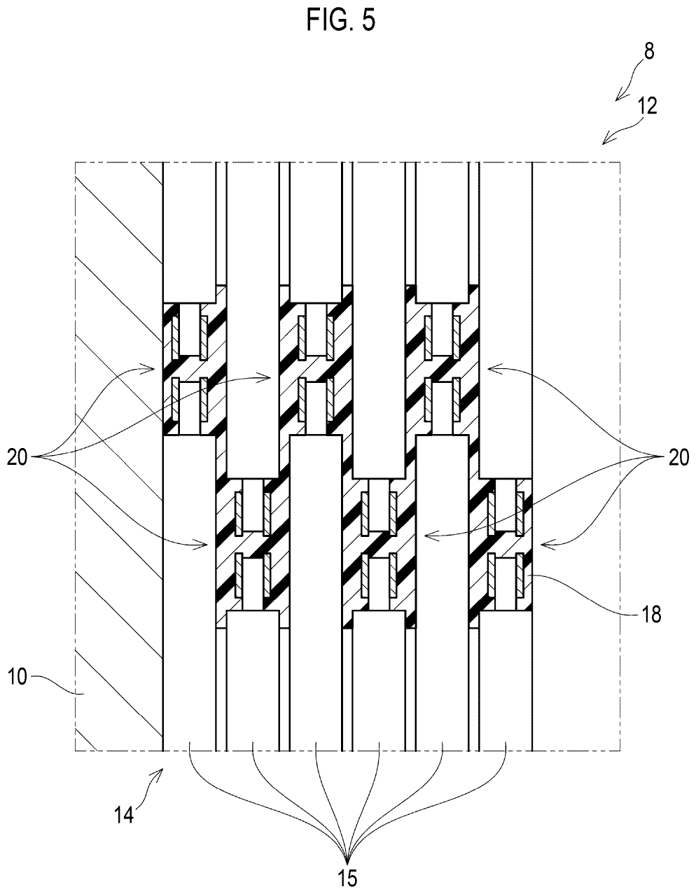

Next, the stator core 10 is heated. The temperature of the raw material 19 of the foaming material disposed inside the fitting member 16 is increased by heating the stator core 10. As described above, the raw material 19 of the foaming material contains a foaming agent. Therefore, the raw material 19 of the foaming material disposed inside the fitting member 16 foams and overflows from the inside of the fitting member 16 to the outside of the fitting member 16 through the through-holes 16a, 16b provided in the side surface of the fitting member 16. Thereafter, as shown in FIG. 5, the foaming material covers each connection portion 20 of the segment coils 15 inside the slot 12. As a result, the insulating material 18 that secures the insulation property between the two connection portions 20 adjacent to each other of the segment coil 15 is formed. With the above manufacturing method, the motor 2 in which the insulation property at each connection portion 20 of the segment coils 15 according to the present embodiment is improved can be easily manufactured.

Although specific examples of the technology disclosed in the present specification have been described in detail above, these examples are merely illustrative and do not limit the scope of the claims. The technology described in the claims includes various modifications and changes of the specific examples exemplified above. The technical elements described in the present specification or the drawings exhibit technical usefulness alone, or in various combinations, and are not limited to the combinations described in the claims at the time of filing. Further, the technology exemplified in the present specification or the drawings can achieve a plurality of objectives at the same time, and achieving one of the objectives has technical usefulness.

What is claimed is:

1. A motor comprising:
a stator core including a plurality of slots;
a stator coil disposed in the slots and configured by connecting a plurality of segment coils; and
an insulating material made of a foaming material having insulation property, the insulating material covering each connection portion of the segment coils, wherein:
each connection portion of the segment coils has a structure in which each end portion of two segment coils where a conductor portion is exposed is fitted into both ends of a fitting member from each end of the fitting member having a cylindrical shape;
at least one through-hole is provided in a side wall of the fitting member having the cylindrical shape; and
the insulating material extends from an inside of the fitting member to an outside of the fitting member through the at least one through-hole.

2. The motor according to claim 1, wherein the at least one through-hole includes a pair of through-holes that open in opposite directions to each other.

3. The motor according to claim 2, wherein the through-holes that open in the opposite directions to each other face each other in a direction orthogonal to an axial direction of the fitting member having the cylindrical shape.

4. The motor according to claim 1, wherein the insulating material is made of a thermosetting resin.

5. A method of manufacturing a motor comprising:
disposing a raw material of a foaming material having insulation property in an inside of a fitting member having a cylindrical shape;
connecting, after the disposing, end portions of two segment coils, where conductor portion is exposed, via the fitting member in slots of a stator core; and
foaming, after the connecting, the raw material of the foaming material positioned in the inside of the fitting member by heating the raw material, wherein:
at least one through-hole is provided in a side wall of the fitting member having the cylindrical shape; and
in the foaming, the foaming material is expanded from the inside of the fitting member to an outside of the fitting member through the at least one through-hole to form an insulating material that covers a connection portion of the two segment coils.
